(19) United States
(12) Patent Application Publication
(10) Pub. No.: US 2011/0202397 A1
(43) Pub. Date: Aug. 18, 2011

(54) Systems and Methods to Deliver Event-Driven Content

(75) Inventors: Keith Lam, Bristol, CT (US); Antonio Gentile, Canton, CT (US)

(73) Assignee: DISNEY ENTERPRISES, INC., Burbank, CA (US)

(21) Appl. No.: 12/705,282

(22) Filed: Feb. 12, 2010

(51) Int. Cl. G06Q 30/00; G06F 17/30

(52) U.S. Cl. 705/14.5; 707/769; 707/E17.014

(57) ABSTRACT

In some embodiments, event data is displayed by receiving, at a client device in communication with a remote content engine, an event message, the event message including data identifying an event type and event data. A determination is made whether the event type of the event message is an ad event, and an event display module is updated with the event data. If the event type is an ad event type, an ad request message is transmitted to the remote content engine, where the ad request message includes data identifying the client device and the event type. An ad response message is received from the remote content engine where the ad response message includes data identifying an advertisement. The advertisement is displayed for the user using the event display module.

### FIELD

The present invention relates to systems and methods to deliver information to users. Some embodiments of the present invention relate to systems and methods for delivering event-driven content, such as advertisements or marketing messages, to users based on the occurrence of events.

### BACKGROUND

Advances in telecommunications, networking and computing have made it possible for users to easily view or otherwise interact with data associated with live events. For example, many users watch or monitor live (or substantially live) sporting events over the Internet on a computer or mobile device. One popular way that users monitor live sporting events is to use a client application which interacts with a remote server over the Internet to receive and display live scoring and statistical data (or “play-by-play” data). Such client applications provide users with current and accurate data about a sporting event.

Users who watch or view such events over the Internet are a desirable audience for many advertisers, and Web based advertisements are commonly presented to these users during events. However, users do not want their viewing experience interrupted during the event. It would be desirable to provide an ability to deliver advertising or other content without interrupting a user's viewing of an event. Further, it would be desirable to provide targeted advertising or other content to increase the relevance of such messaging to individual users.

### BRIEF DESCRIPTION OF THE DRAWINGS

FIG. 1 is a block diagram overview of a system.

FIG. 2 is a flow chart of a method according to some embodiments of the present invention.

FIG. 3 is a representation of a user interface in accordance with some embodiments of the present invention.

FIG. 4 is a representation of a user interface in accordance with some embodiments of the present invention.

FIG. 5 is a tabular representation of a portion of a lookup table in accordance with some embodiments of the present invention.

FIG. 6 is a tabular representation of a portion of a lookup table in accordance with some embodiments of the present invention.

### DETAILED DESCRIPTION

Applicants have recognized that there is a need for methods, systems, apparatus, means and computer program products for delivering event-driven advertisements or other messages to users.

In some embodiments, event data is displayed by receiving, at a client device in communication with a remote content engine, an event message, the event message including data identifying an event type and event data. A determination is made whether the event type of the event message is an ad event, and an event display module is updated with the event data. If the event type is an ad event type, an ad request message is transmitted to the remote content engine, where the ad request message includes data identifying the client device and the event type. An ad response message is received from the remote content engine where the ad response message includes data identifying an advertisement. The advertisement is displayed for the user using the event display module.

In some embodiments, a subsequent event message is received from the remote content engine causing the termination of a display of the advertisement. In some embodiments, the display of the advertisement may be terminated upon receipt of at least one of: (i) a subsequent event message from the remote content engine, (ii) a request from a user to terminate display of the advertisement, and (iii) a time expiration of the advertisement.

Prior to a discussion of these and other features in further detail (which will be provided below, by describing a system, individual devices, exemplary databases and processes according to some embodiments of the invention), a brief illustrative (but not limiting) example of the operation of some embodiments will be provided.

In the illustrative example, a user (“John”) wants to watch his favorite basketball team play against a big rival. John isn't able to watch the game on television and chooses to watch the game substantially in real time on his computer. John visits his favorite sports website over the Internet and selects an option to watch the game on his computer. By selecting the option, an event display application is downloaded or activated on John's computer. The event display application may be coded using Adobe® Flash technology or a similar technology which allows rich interactive content to be displayed on a client device.

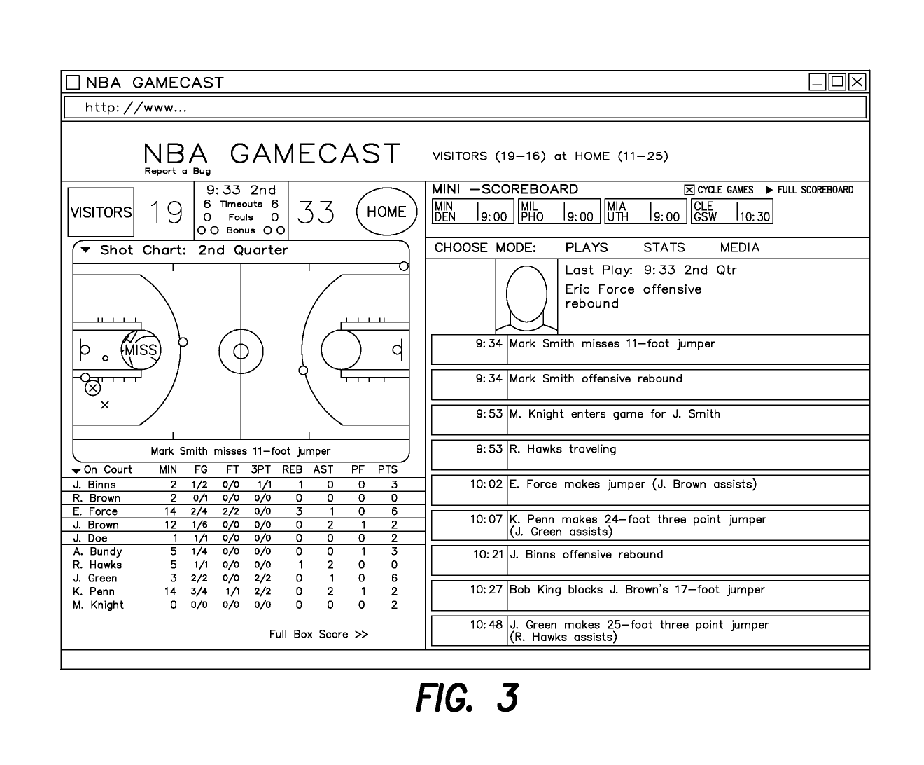

A user interface is presented to John on his computer (such as the user interface that will be described further below in conjunction with FIG. 3). The user interface allows John to follow the game as the game happens, with real-time statistics, scoring and other information. In basketball, and in other sporting and live events, there are often types of events or actions which are followed by a break in the action. For example, when a time out is called, there is a short break in the action during which no scoring or statistical updates are provided to the user interface. Embodiments of the present invention use these breaks in action to present targeted advertisements or other messages to the user interface. In this way, embodiments ensure that viewers (such as John), are not disrupted by advertisements or other messages during the actual event. Instead, advertisements or other messages are presented during natural breaks in the action. Pursuant to some embodiments, the advertisements or messages are targeted to the John's specific situation or profile. For example, an advertisement may be selected based on John's affinity to a specific basketball team or based on John's geographical location.

Further details and features of some embodiments of the present invention will now be described. The illustrative example introduced above will be revisited to further illustrate features of some embodiments.

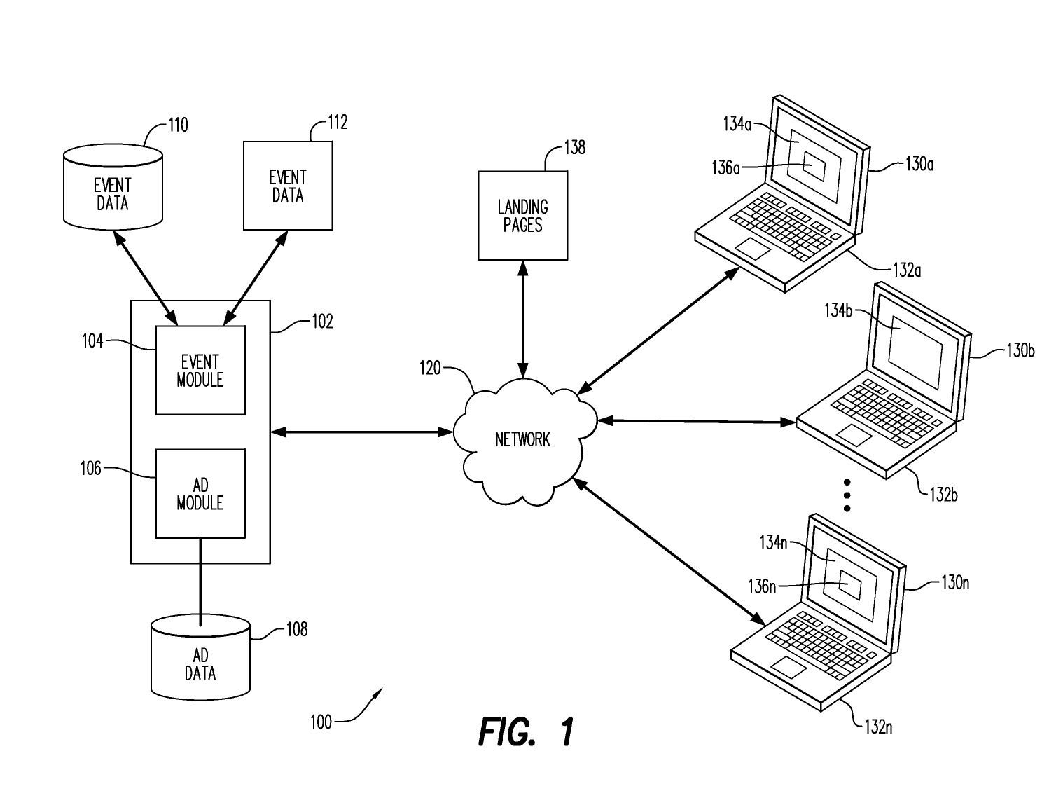

Reference is now made to FIG. 1, which is a block diagram overview of a system 100 wherein a user may access information via a communication network 120. For example, a user might enter a web address or select a web link via a user device 132, such as a personal computer (“PC”). Selecting the web link or web address may cause an application to be launched (or, in the event of a first use of the application, an installation of the application on the user device 132 and then a launch of the application) on the user device 132.

Pursuant to some embodiments, the application is a rich interactive content application, developed using technology such as Adobe® Flash or the like, which causes a user interface to be displayed in a screen region 134 of a display device 130 of the user device 132. In some embodiments, the program may be downloaded from content engine 102 or another remote server prior to use. The program may display information received from content engine 102 such as, for example, near real-time event data and graphics. For example, the program may be the GameCast program offered by ESPN®, and the data displayed may be sporting event data and statistics (although those skilled in the art will appreciate that embodiments may be used in conjunction with other types of live events, such as news casts, auctions, or the like).

Pursuant to some embodiments, one or more advertisements 136 or other messages may be displayed within a screen region 134 of the display device 130. As will be described further herein, pursuant to some embodiments, the advertisements 136 are displayed in response to event data associated with an event being viewed by a user operating user device 132.

For example, continuing the illustrative example introduced above (where a user named John is viewing a basketball game on his computer), embodiments allow the presentation of relevant advertisements on John's computer screen during time periods which will not disrupt John's viewing of the game. For example, John may be presented with an advertisement during a time out in the basketball game. The advertisement may be removed from John's screen as soon as play resumes after the time out (or as soon as new data associated with the game is received by John's computer). In this way, John's viewing experience is not disrupted, and advertisers are able to deliver marketing messages to John during a game.

Referring again to FIG. 1, the advertisement 136 (or “ad”) is a message, content or other information presented to a user. Pursuant to some embodiments, an advertisement 136 may be or include content in the form of creatives or files that include text, graphics, and/or audio files associated with an advertised product or service or other message. The advertisements 136 can, for example, be in the form of graphical ads, such as banner ads, text only ads, image ads, audio ads, video ads, ads combining one of more of any of such components, etc. The advertisements 136 can also include embedded information, such as links, meta-information, and/or machine executable instructions.

In some embodiments, the advertisement 136 includes both a creative and a link (such as a uniform resource locator or “URL”) to a particular page of a website, such as a landing page 138. A landing page 138 may be a page that a user is directed to when the user clicks (or otherwise interacts with) on an advertisement 136 presented on a display device 130 of a user device 132.

In some embodiments, the advertisement 136 may also be associated with one or more tracking variables or links. For example, in some embodiments, the advertisement 136 is associated with an impression pixel or other tracking code which allows the content engine 102 to track the number of impressions and click-throughs associated with the display of a particular advertisement 136. The tracking variables may track, for example, the number of conversions or click throughs associated with a particular advertisement 136. In some embodiments, the tracking may also track how many users click through an advertisement and perform a desired action on an associated landing page 138.

Pursuant to some embodiments, the event data (such as the scoring, statistics, play by play information, etc.) are received over a network 120 from a content engine 102. The event data is provided via an event module 104 which aggregates, identifies, and distributes event data to one or more remote user devices 130 which are operating a program (such as the GameCast program from ESPN®) to view an event. The event data provided by the event module 104 includes event data from an event database 110 and event data provided by other event data sources 112. For example, in the illustrative example of a user receiving event data about a particular basketball game, the event data collected and distributed by the event module 104 include statistical data about players and teams (which may be received from an archive of event data 110) and information about the game as the game progresses. The information about the game may include data received from correspondents or editors watching the game and entered into an interface to create the event data 112.

Each item of information is provided as a structured data set that may include a number of attribute and value pairs. Attributes may be common to many events and identify a characteristic of an event (e.g., such as a score, game clock, player name, play, etc.). Values corresponding to an attribute may include the actual event data (e.g., a value for the attribute “Player Name” may be “Adrian Peterson”). This structured data allows event data to be parsed and presented on a display screen in a repeatable and easily viewable manner. Attributes may also be associated with an “event type” which identifies an event as an event after which an advertisement should be displayed. For example, in a basketball game, event data may include event types such as events related to scoring, player statistics, play by pay data, other game data, etc. Events may also include time outs, end of quarters, and the like. The structured data may be used to indicate how the corresponding event data (or values) are displayed on a screen region 134. For example, a style sheet and associated HTML code may specify that scoring data be presented in a particular location on the screen region 134 (so that the data may be styled and presented in a way that is consistent and easily readable to a user). Pursuant to some embodiments, event types may also be used to indicate when an advertisement 136 should be displayed within the screen region 134. In some embodiments, this identification of whether an event type should result in the display of an advertisement 136 is performed by a look up of a received event type with a stored table of event types that are advertisement event types.

For example, when event data is received at a user device 132, the event type of the data is compared to a table of event types to determine if the received event type is an advertisement event type. If the received event data is an advertisement event type, the user device 132 requests an advertisement from the content engine 102. When an advertisement is received, it is then displayed within the screen region 134. Pursuant to some embodiments, the advertisement may remain on the screen until it either expires (as described further below), until new event data is received (which causes the advertisement to be taken off the screen region 134 so the new event data can be displayed), or upon receipt of a cancel or other command from a user. In this way, advertisements can be presented to users only during breaks in action of the event being viewed.

Receipt of an advertisement 136 may include receipt of data identifying the location of an advertisement image as well as receipt of any related tracking information (such as an impression pixel) and an associated link to a landing page. For example, the content engine 102 may transmit a message to a user device 132 that includes: a URL identifying a location of the advertisement graphic, a URL to a tracking or impression pixel, and a URL to a landing page 138 associated with the advertisement.

Pursuant to some embodiments, the advertisements 136 are retrieved by the content engine 102 using an ad module 106. The ad module 106 may apply stored logic and rules to select an appropriate advertisement for display in response to a request from the user device 132. A number of different rules may be used to select an advertisement. For example, an advertisement may be selected based on the event type that caused the request. An event type that is associated with a relatively long break in the action (such as the end of a quarter in a basketball game, for example) may result in the selection of an advertisement that is designed for a relatively long break in the action. For example, a Flash or video advertisement that lasts for 30 seconds may be selected. An event type that is associated with a relatively short break in the action, such as a time out, may result in the selection of an advertisement that is designed for a shorter break in the action. For example, a 15 second long Flash or video advertisement may be selected for display during a time out.

The ad module 106 may apply other criteria as well when selecting an appropriate advertisement for display. For example, an advertiser may specify that it wishes its ads to only be displayed during football games. As a result, when an ad request is received from a user viewing a basketball game, the ads targeted for football games will not be selected. Other targeting may also be performed based on user characteristics and other information. For example, instead of displaying advertisements to an entire population of users, advertisers can specify that certain advertisements are to be restricted to a certain subset of users that can be identified based on their attributes. For example, the ad module 106 may include targeting rules that can identify users that should receive advertisements 136 based on data associated with those users.

The ad module 106 may receive such rules or conditions from advertisers and store those rules in an ad database 108. When an advertisement request is received from a user device 132, user data may be associated with the request and compared to the stored rules or conditions to identify those users whose attributes and values satisfy the advertiser's specified conditions. For example, an advertiser may specify that a particular advertisement should only be shown to users who are located in New York, who are over the age of 21, and who are viewing a basketball game. This allows advertisers to target identifiable subsets of users. The user attribute data may be obtained programmatically (e.g., for the case of a geographical attribute, via a reverse IP address lookup or other geo targeting techniques) or via stored data provided by a user when the user registers to access and view an event.

As used herein, devices (such as the user devices 132 and the content engine 102) may communicate via the communication network 120, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network (such as the Internet, an intranet or an extranet). Note that the devices shown in FIG. 1 need not be in constant communication. For example, the user device 132 may only communicate with the content engine 102 on an as-needed basis. In some embodiments, for example, the user device 132 may be a PC that intermittently utilizes a dial-up connection to the Internet via an Internet Service Provider (ISP). In other embodiments the user device 132 may be in constant and/or high-speed communication with the content engine 102 through the use of any known or available connection device such as a cable or Digital Subscriber Line (DSL) modem. According to some embodiments, the communication network 120 may be or include multiple networks of varying types, configurations, sizes, and/or functionalities.

Although a single content engine 102 is illustrated in FIG. 1, any number of such devices may be included in the system 100. Similarly, any number of the other devices described herein may be included in the system 100 according to embodiments of the present invention. A content engine 102 may, for example, be in communication with multiple user devices 132a-n. In some embodiments, multiple content engines 102 and/or related devices may provide various event data and information as well as advertising or other messages to users operating user devices 132a-n. Different user devices 132a-n may view different event data simultaneously. For example, a user operating user device 132a may be viewing data associated with a basketball game while a user operating user device 132b may be viewing data associated with a football game. Each user will view advertisements based on the event data associated with their viewing session.

The user devices 132 and the content engine 102 may be any devices capable of performing various functions described herein. A user device 132 may be, for example: a PC, a portable computing device such as a Personal Digital Assistant (PDA), a mobile phone with a Web browser, an interactive television device, or any other appropriate storage and/or communication device. The content engine 102 may be, for example, a web server (or a number of web servers) that provides web pages for a browser application of the user device 132 (e.g., such as the INTERNET EXPLORER® browser application available from MICROSOFT®).

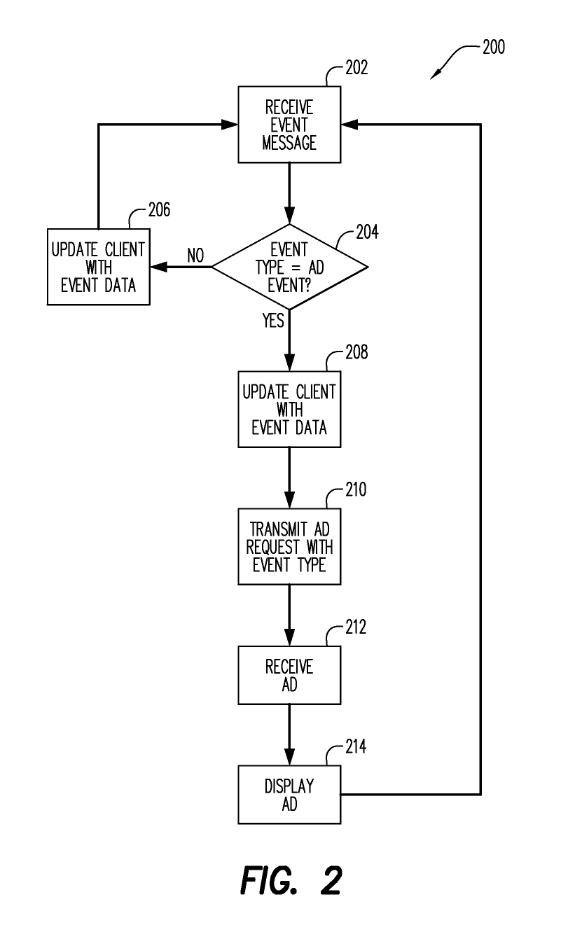

Pursuant to some embodiments, when a user is viewing an event using features of the present invention, the requesting and display of advertisements based on event data is initiated by the user device. For example, reference is now made to FIG. 2, where a flow chart of a method 200 that may be performed by a user device 132 (in communication with a content engine 102) is shown. The flow charts described herein do not necessarily imply a fixed order to the actions, and embodiments may be performed in any order that is practicable. Note that any of the methods described herein may be performed by hardware, software (microcode), or any combination of these approaches. For example, a storage medium may store thereon instructions that when executed by a machine result in performance according to any of the embodiments described herein.

The process 200 may be performed by a user device 132 which has installed and is operating a program (such as the GameCast application provided by ESPN®) to view an event (such as a sporting event or the like). That is, a user operating the user device 132 has downloaded or otherwise launched the application, and has started watching an event using the application.

Processing begins at 202 where the user device 132 receives an event message from the content engine 102. For example, the event message may be a data packet received over a network connection which includes data associated with a game or other event that the user is viewing. The data packet may identify one or more attributes and values associated with the event that have occurred, and that should result in an update to a screen area of the user device. For example, the event message may include an update to the game clock, or an update to the score, along with any play by play information. The event message may also include data specifying an event type. In some embodiments, the event message may be transmitted in a uniform packet format such that the client device may parse and identify the attributes and associated values and cause those values to be displayed on a display device.

Processing continues at 204 where code associated with the user device 132 parses the event message received at 202 to determine if the event type is an ad event. For example, processing at 204 may include parsing the received event message to determine if an advertisement request should be triggered (described at 210 as an “ad request message”). An advertisement request may be triggered in a number of ways. In some embodiments, the client device parses the received event message to identify an “event type” of the event message. The event type may then be compared to a lookup list to determine if the received event data is for an event that will be followed by a break in the event action (e.g., such as a time out, an end of a quarter, etc.) such that an advertisement could be displayed during the break in the action. According to some embodiments, the lookup list may be maintained in-memory. According to other embodiments, the lookup list may be stored and/or maintained in a relational database stored at, or accessible to, the user device 132. In some embodiments, the lookup list may be updated from time to time as new event types are identified or modified. If processing at 204 indicates that the received event message is associated with an event type that is not an ad event, processing continues at 206 where the client application is updated with the event data as normal. For example, processing at 206 may result in an update to the graphical user interface displayed to a user to show the updated event data (e.g., such as an update to the score, a play by play message, the clock, etc.).

An advertisement request message may be triggered in other ways as well. For example, an event message that contains an event type for which an advertisement may be triggered may contain additional metadata or tag information which allows the client device to readily identify the event type as one that should trigger an advertisement request (discussed below as the ad request message). In this manner, the client device need not perform a lookup as described above. In some embodiments, a combination of metadata, tags or lookups may be used to identify individual events as event types that should trigger an advertisement request message.

If processing at 204 indicates that the received event message is associated with an event type that is an ad event, processing continues at 208 where the client application is updated with the event data (similar to the update performed at 206). However, processing continues at 210 where the client application generates and transmits an ad request message to the content engine 102. The ad request message includes data identifying the event type. For example, if the event message received at 202 is associated with a time out event type, then the ad request message generated and transmitted at 210 will identify the ad request as being associated with a time out event. In some embodiments, the ad request message transmitted at 210 may also include information identifying the user associated with the client application (e.g., via a user account identifier, a cookie, geotargeting data, or the like), as well as the specific event (e.g., such as a code or identifier uniquely identifying the specific game or live event).

The ad request message is processed by the content engine 102 (e.g., using the ad module 106) to select an appropriate advertisement or other messaging to present to the user via the client application. In some embodiments, the advertisement is selected based on the event type. For example, if the event type is a time out in a basketball game, an appropriate advertisement might be an advertisement that can be presented in a time slot of less than 30 seconds. If the event type is an end of quarter or period of play, the selected advertisement might be a longer advertisement (e.g., a video ad that takes longer than 30 seconds to play). Pursuant to some embodiments, other criteria may be used by the ad module 106 to select an appropriate ad. For example, in some embodiments, information about the user viewing the content may be used to select an ad to provide a more customized and relevant advertisement or message for the user. The user may be identified via a customer profile (in the case where the user has logged in and established a profile prior to viewing the event) or via an IP address, geo-location data, cookies, or the like. In some embodiments, the advertisement to be provided may also be selected based on a combination of variables, such as the event type, the user, and the specific event being viewed.

As an illustrative example, continuing the example introduced earlier, the basketball fan who is viewing a game online may be presented with an advertisement that is based on his user profile and location. The selected advertisement may be one that relates to the game John is watching as well as information about John from his profile. The selected advertisement may contain textural information about the game, or any game in progress, that is related to user profile, affinity, and/or location. In this way, advertisements can be presented at appropriate times during an event (without disrupting the viewing experience) with targeted and relevant messaging.

Once a relevant or appropriate advertisement is selected at the content engine 102, it is returned in a message to the client application at 212. Processing at 212 includes receiving an ad response message and displaying the advertisement to the user on the user device 132. In some embodiments, the ad response message includes details such as the location of the advertisement (e.g., such as an image or other URL), impression or tracking information (e.g., such as a unique tracking pixel URL), display information (e.g., such as a location for the advertisement on a display device, a duration or timer for presentation of the advertisement, etc.), and a URL to a landing page 138 associated with the advertisement.

In some embodiments, the ad response message may include information allowing the client device to retrieve and display an advertisement or other message that was previously stored at, or accessible to the client device. For example, in some embodiments, when a user operating a user device 132 first installs (or subsequently updates) the client application (e.g., such as GameCast), the client application may include a set of advertisements or messages that are stored on the client device. These advertisements or messages may have identifiers allowing the client application to retrieve and display them based on data received from the content engine 102 (e.g., in an ad response message). Other techniques for identifying and displaying advertisements or other messages may also be used to efficiently retrieve, identify and display targeted messaging in response to an ad response message.

Pursuant to some embodiments, an ad response message may contain a text element (which may be created or selected based on a combination of user profile or other demographic information and statistical data associated with the event being viewed) such that a targeted and relevant message may be displayed to the user operating the user device 132. For example, in the illustrative example where John is a fan of one of the NBA teams playing in the game he is watching, a targeted message may be displayed on John's screen telling him that “Your favorite team made the playoffs and will play the Lakers on June 16—buy a game package to LA now and save!”. In such embodiments, the advertisement message may be selected based on a combination of information, including the event data, user data, and statistical data (e.g., stored at or accessible to the content engine 102).

Processing continues at 214 where the advertisement received in the ad response message at 212 is displayed for the user on a screen region 134 of the display device 130 of the user device 132. The advertisement may be displayed for a predetermined time period (e.g., a 15 second video ad may display for 15 seconds), or until a subsequent event message is received at 202. When a subsequent event message is received by the client application, the advertisement may be automatically removed from the screen region 134 of the display device 130 so that the event data associated with the subsequent event message may be displayed for the user. In this manner, embodiments allow advertisements to be displayed at appropriate times during the viewing of an event in a manner that does not interrupt or interfere with a user's viewing of the event. In some embodiments, a user may be given the option to close an advertisement by clicking on a button or region on the advertisement to manually remove it from the display. The process 200 continues until the event is completed or until the user closes or otherwise terminates the application.

While the process 200 is described as checking for an ad event first (at 204) and then updating a display (at 208), those skilled in the art will appreciate that the sequence may be reversed, be performed substantially simultaneously, or performed in a different sequence. For example, in some embodiments, when an event message is received, the variables contained in the message may first be used to update the display device 130, and then analyzed to determine if it is associated with an ad event. Further, although the ad response message is described as receiving

Reference is now made to FIG. 3, where an example of a display 300 according to some embodiments is shown. The display 300 may, for example, be associated with the method 200 described above, and may be displayed on a display device 130 of a user device 132. In some embodiments, the display 300 may be rendered using a client application such as the GameCast application offered by ESPN® or another rich interactive content application. The data displayed on the display 300 is provided to the application by a remote server such as the content engine 102. As shown, the display 300 provides a wide variety of data about a specific event being viewed by a user. In the illustrative example display, the user is viewing a basketball game, and the game is in progress (e.g., there is not currently a break in the action). As a result, pursuant to some embodiments, no advertisement is currently shown on the display 300.

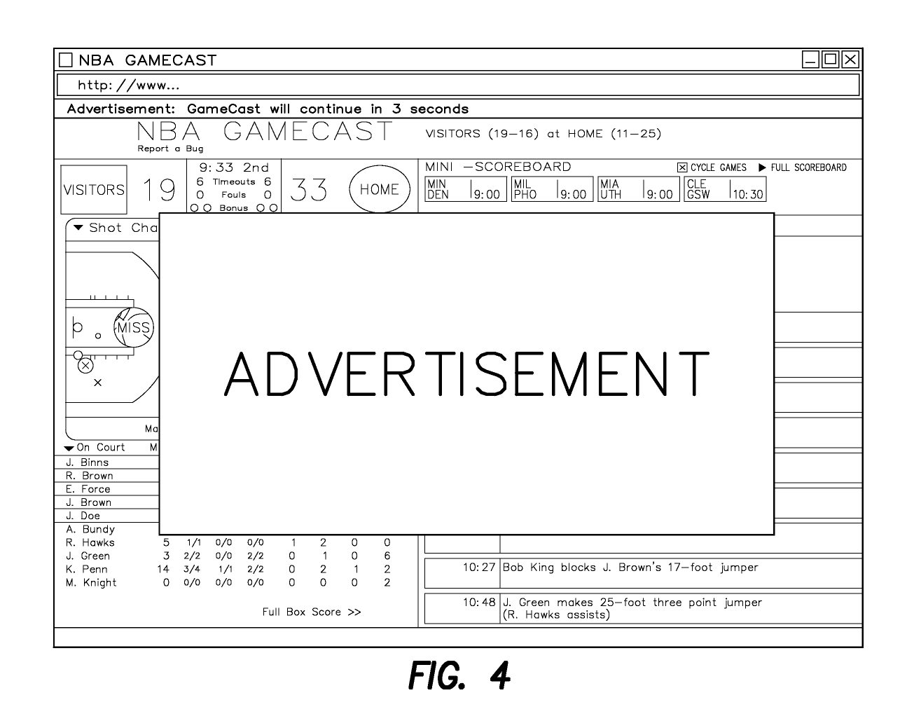

Turning now to FIG. 4, a similar display 400 is shown which represents the data viewed by a user during the same basketball game. However, in the display 400, an advertisement 402 is shown (in the example display 400, the advertisement is shown as an overlay on top of the screen, however, those skilled in the art will recognize that the advertisement could be positioned within the display screen in other ways and that the positioning of FIG. 4 is for illustration). The display 400 represents a point in time after the user device has received an event message having an event type of an ad event and the user device has transmitted an ad request message (and has received an ad response message). The specific content of the advertisement 402 will depend on the ad selection logic of the ad module 106. The advertisement may be one that is specifically targeted to the user or an ad selected based on other logic as described herein.

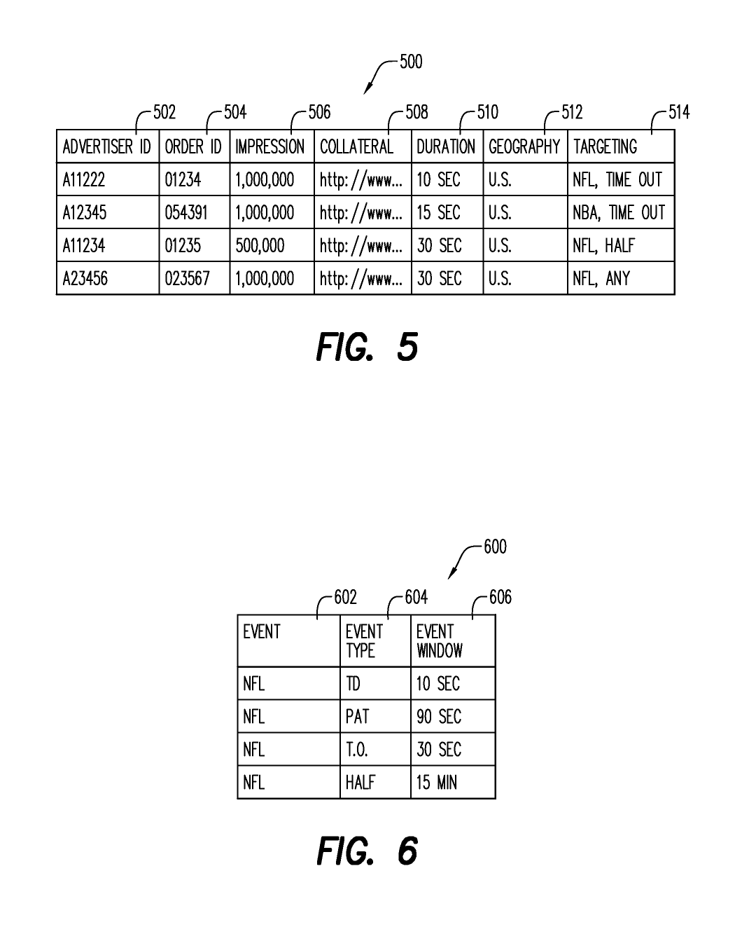

As described above, a number of databases or data tables may be used to store data for use in identifying ad events and selecting advertisements for display based on those ad events. For example, the content engine 102 may store (or have access to) an ad database which stores a table (such as the table 500 of FIG. 5) storing ad targeting data. The table may include, for example, entries identifying specific advertiser orders and targeting data, as well as the ad collateral and impression or other order data. The table may be consulted each time an ad request message is received from a user device 134 (e.g., such as in response to step 210 of the method of FIG. 2). The table may also define fields 502-514 for each of the entries.

The fields may, according to some embodiments, specify: an advertiser identifier 502 (representing a specific advertiser), an order identifier 504 (representing a specific insertion or order of advertisements by the advertiser), an impression count 506 (representing a total number of impressions the advertiser wishes an ad to receive), a collateral path 508 (including a URL or other path to the advertisement collateral), a duration 510 (specifying the play time desired for each impression of a particular advertisement), a geography 512 (specifying the geographical region in which the ad is eligible to be displayed), and other targeting criteria 514. The other targeting criteria 514 may include data specifying characteristics of a user, an event, an event type or the like for which the advertisement is to be displayed. For example, an advertiser may specify that a specific advertisement or order be displayed only in the U.S., during NFL football games, and only after a time out has been called. As described above, further targeting may also be performed based on specific data or characteristics associated with a user or an event.

Note that the table 500 might store other types of information in addition to, or instead of, the information illustrated in FIG. 5. For example, in some embodiments, dynamic insertion of advertisement text or messaging may also be specified in the table. As a specific example, a travel company may wish to advertise NBA playoff game travel packages to users who are watching an NBA playoff game with playoff implications. The advertiser may specify targeting criteria which include: the event type (a specific NBA game), a user profile (fans of the team that may make the playoffs), and an event type (e.g., such as a time out). The advertising message may be based on the current score or other event data to further personalize or target the message. A resulting advertisement may include a message such as: “The Knicks are up 78-74. Book a travel package now to see them in the playoffs.”

Those skilled in the art, upon reading this disclosure, will recognize that other targeting and delivery of relevant advertisements may also be provided using features of the present invention, and that other types of data may be stored in the ad database 108 and that the data shown in the table 500 of FIG. 5 is for illustrative purposes only.

Pursuant to some embodiments, the types of events that trigger an ad request message may vary. An example ad event table 600 is shown in FIG. 6. The ad event table 600 may be stored at one or both of the content engine 102 and user device 132, and may be used when processing event data to identify events as ad events (e.g., such as in conjunction with process 200 at step 204). As shown in FIG. 6, an ad event table 600 may include a number of events 602 (such as different kinds of live events that may be viewed), corresponding event types 604 (such as a particular event within a game that is eligible for triggering an ad display), and, in some embodiments, an event window 606 (which specifies a duration of display for an ad). The event window 606 is used, in conjunction with the event type 604, to identify whether an advertisement from the table 500 may be displayed after a particular event type 604. For example, an ad having a 30 second duration will not be displayed after the occurrence of an event type having an event window of 10 seconds. In this manner, embodiments allow ads to be selected based on the occurrence of events within a live event viewing session such that the ads are relevant and do not disrupt a user's viewing of the live event.

The embodiments described herein do not constitute a definition of all possible embodiments, and those skilled in the art will understand that many other embodiments may be possible and/or practicable.

For example, while embodiments have been described in which events are identified as representing breaks in the action in which an advertisement may be presented, other events may also be used to provide targeted messaging. For example, advertisers may designate that advertisements or messaging be displayed to certain users based on other event types to provide logical and relevant messaging to users. As a specific example, an advertiser may specify that a particular advertisement be displayed to users during a baseball game each time one of the teams hits a home run. An advertiser may specify even more granular rules and indicate that a specific advertisement be displayed each time a particular player hits a home run. Embodiments of the present invention allow advertisers to target each of these plays, actions or events during the course of a game or other live event, thereby increasing the relevance and timeliness of advertising messages to users.

Embodiments have been described in which an application on the client device is operated to request an advertisement (based on the client device having received event data which it identifies as an ad event). In some embodiments, the content engine 102 or other remote device may be responsible for requesting or identifying events as ad events.

Further, although the embodiments are briefly described for clarity, those skilled in the art will understand how to make any changes, if necessary, to the above-described apparatus and methods to accommodate these and other embodiments and applications.

We claim:

1. A method for operating a client device to display event data on a display device, comprising:
receiving, from a remote content engine, an event message, said event message including data identifying an event type and event data;
determining that the event type of said event message is an ad event;
updating said display device with said received event data;
transmitting an ad request message to said remote content engine, said ad request message including data identifying said client device and said event type;
receiving, from said remote content engine, an ad response message, said ad response message including data identifying an advertisement; and
displaying said advertisement on said display device.

2. The method of claim 1, wherein said data identifying an advertisement includes at least one of: (i) the advertisement, (ii) data specifying a path to retrieve the advertisement, and (iii) data identifying an advertisement stored at said client device.

3. The method of claim 1, further comprising:
terminating said displaying of said advertisement upon receipt of at least one of: (i) a subsequent event message from said remote content engine, (ii) a request from a user to terminate display of said advertisement, and (iii) a time expiration of said advertisement.

4. The method of claim 1, wherein said event display module is at least one of a flash application and a rich media application.

5. The method of claim 1, wherein said determining that the event type of said event is an ad event includes at least one of: (i) comparing said data identifying an event type with a stored table of event types, and (ii) receiving metadata identifying said event type as an ad event.

6. The method of claim 1, wherein said updating said display device with said event data includes updating a display variable of an event display module with said event data and refreshing said display device.

7. The method of claim 1, wherein the data identifying the advertisement is selected based at least in part on said event type.

8. The method of claim 1, wherein said transmitting an ad request message further comprises: transmitting information associated with at least one of: (i) a user of said client device, and (ii) said client device.

9. The method of claim 8, wherein said data identifying an advertisement is selected based on at least one of: (i) said event type; (ii) said information associated with said user of said client device; and (iii) said information associated with said client device.

10. A user device, comprising:
a communication interface;
a display device;
a processor coupled to the communication interface and to the display device; and
a storage device in communication with said processor and storing instructions adapted to be executed by the processor to:
receive, from a remote content engine, an event message, said event message including data identifying an event type and event data;
determine that the event type of said event message is an ad event;
update said display device with said received event data;
transmit an ad request message to said remote content engine, said ad request message including data identifying said client device and said event type;
receive, from said remote content engine, an ad response message, said ad response message including data identifying an advertisement; and
displaying said advertisement on said display device.

11. The device of claim 10, further comprising:
an event type lookup list storage element, wherein the event type lookup list storage element is associated with at least one of: (i) in-memory storage, or (ii) a relational database.

12. A computer-implemented method, comprising:
receiving, from a client device, a request to receive event data associated with an event;
transmitting an event message to said client device, said event message including data identifying an event type and event data;
receiving, from said client device, an ad request message in response to said event message, said ad request message including data identifying said client device and said event type;
selecting an advertisement having display criteria matching said event type; and
transmitting said advertisement to said client device in an ad response message.

13. The computer-implemented method of claim 12, wherein said receiving a request to receive event data further comprises:
receiving user profile data from a user operating said client device.

14. The computer-implemented method of claim 12, wherein said event type in said event message comprises an ad event.

15. The computer-implemented method of claim 12, wherein said selecting an advertisement further comprises:
querying an ad database to identify an advertisement having display data matching said event type.

16. The computer-implemented method of claim 13, wherein said selecting an advertisement further comprises:
constructing a query including said event type and said user profile data; and
querying an ad database to identify an advertisement having display data matching said query.

17. The computer-implemented method of claim 12, further comprising:
transmitting a subsequent event message to said client device, said subsequent event message including data identifying an event type and event data, said subsequent event message causing said advertisement to be removed from a display device of said client device.

18. The computer-implemented method of claim 12, wherein said ad response message further comprises data identifying a collateral location, data identifying a display characteristic, and data identifying a landing page location.

19. The computer-implemented method of claim 13, wherein said selecting an advertisement further comprises:
identifying an advertisement based on said event type, said user profile, and statistical information associated with said event; and
personalizing said advertisement based on said event type, said user profile, and said statistical information.
